(19) United States
(12) Patent Application Publication
(10) Pub. No.: US 2026/0365154 A1
(43) Pub. Date: Nov. 19, 2026

(54) PATTERN RECOGNITION BASED VEHICLE MASS ESTIMATION

(71) Applicant: Cummins Inc., Columbus, IN (US)

(72) Inventors: Shailesh Nair, Pune (IN); Vikas Kundlik Ubale, Pune (IN); Pradheepram Ottikkutti, Erie, PA (US)

(73) Assignee: Cummins Inc., Columbus, IN (US)

(21) Appl. No.: 19/480,576

(22) PCT Filed: May 2, 2024
(86) PCT No.: PCT/US2024/027564

§ 371 Date: Oct. 31, 2025

(30) Foreign Application Priority Data
May 3, 2023 (IN) 202341031478

(51) Int. Cl. B60W 10/08; B60W 40/13; B60W 50/00; G06N 20/20

(52) U.S. Cl. CPC B60W 10/08; B60W 40/13; B60W 50/00; G06N 20/20; B60W 2050/0031; B60W 2050/0052; B60W 2510/0638; B60W 2510/081; B60W 2510/18; B60W 2520/10; B60W 2530/10

(57) ABSTRACT

Systems and methods for determining a value regarding a system, such as a vehicle, to enable control of the system are provided. Method includes: receiving an indication of a transmission of a vehicle being in a continuously single setting; receiving an indication of a brake event of the vehicle; determining a first energy value regarding the vehicle based on the transmission being in the continuously single setting and the indication of the brake event; receiving an indication of a change in operation of at least one of the transmission and the brake event; determining a second energy value regarding the vehicle based on the indication of the change in operation of the at least one of the transmission and the brake event; based on the first and second energy values, determining a value regarding the vehicle; and controlling operation of a component of the vehicle based on the determined value.

### CROSS-REFERENCE TO RELATED APPLICATION

This application claims the benefit of and priority to Indian Provisional Patent Application No. 202341031478, filed May 3, 2023, and titled “PATTERN RECOGNITION BASED VEHICLE MASS ESTIMATION,” which is incorporated herein by reference in its entirety and for all purposes.

### TECHNICAL FIELD

The present application relates to systems and methods for dynamically determining a mass of a system, such as a vehicle, to enable control of the system, components or sub-systems thereof, and/or other for reporting purposes (e.g., to various agencies).

### BACKGROUND

The mass of a vehicle (such as a cargo carrying vehicle like a truck) is often information utilized for the control and operation of the vehicle. For example, the mass of the vehicle may be used to determine a driving resistance for the vehicle (or load on the vehicle) in order to forecast future action(s) of the vehicle. Further, the mass of the vehicle may be used to develop driver assistance programs as well as manage and control the vehicle. Typically, the mass of a vehicle may be determined or estimated based on one or more sensors on the vehicle (e.g., load sensors). However, the use of sensors adds cost and complexity to determining the mass of the vehicle. Moreover, sensors can be subject to malfunction and/or tampering thereby leading to inaccuracies in the information from the sensors and/or determinations based on the sensor information. Therefore, systems and methods for estimating the mass of a vehicle without or substantially without the use of sensors are desired.

### SUMMARY

One embodiment relates to a method. The method includes: receiving vehicle operating data, filtering the vehicle operating data, determining a plurality of data values for a first vehicle data type and a plurality of data values for a second vehicle data type based on the filtered vehicle operating data, determining, by a machine learning model, a relational pattern between the plurality of data values for the first vehicle data type and the plurality of data values for the second vehicle data type, based on the relational pattern between the plurality of data values for the first vehicle data type and the plurality of data values for the second vehicle data type, determining a value regarding the vehicle, controlling operation of a component of the vehicle based on the determined value.

In some implementations, the determined value is an estimated mass of the vehicle. In some implementations, the first vehicle data type and the second vehicle data type are at least one of a vehicle speed, a vehicle power, an engine speed, a motive power source rotational speed, a net brake torque, a fueling value, a motor speed, a motor current and a motor voltage, a service brake value that may be indicative of a service brake status, a clutch value, or a gear value. In some implementations, the first vehicle data type is different from the second vehicle data type. In some implementations, the filtering the vehicle operating data comprises applying at least one of an averaging filter or a windowing filter. In some implementations, controlling the operation of the component includes controlling the transmission or a power output from a power source of the vehicle. In some implementations, the machine learning model includes at least one of a random forest model, a statistical learning model, a neural network, or a regression model. In some implementations, the method further includes training the machine learning model using vehicle operating data values and validating the trained machine learning model to determine the best performing machine learning model to deploy.

Another embodiment relates to a system for determining a value regarding a vehicle that is used to control the vehicle. The system includes one or more processors and at least one memory coupled to the one or more processors. The at least one memory stores executable instructions, which when executed by the one or more processors, cause the one or more processors to receive vehicle operating data, filter the vehicle operating data, determine a plurality of data values for a first vehicle data type and a plurality of data values for a second vehicle data type based on the filtered vehicle operating data, determine, by a machine learning model, a relational pattern between the plurality of data values for the first vehicle data type and the plurality of data values for the second vehicle data type, based on the relational pattern between the plurality of data values for the first vehicle data type and the plurality of data values for the second vehicle data type, determine a value regarding the vehicle, and control operation of a component of the vehicle based on the determined value.

Another embodiment relates to a non-transitory computer readable medium. The non-transitory computer readable medium stores instructions therein that, when executed by one or more processors, cause the one or more processors to perform operations. The operations include receiving vehicle operating data, filtering the vehicle operating data, determining a plurality of data values for a first vehicle data type and a plurality of data values for a second vehicle data type based on the filtered vehicle operating data, determining, by a machine learning model, a relational pattern between the plurality of data values for the first vehicle data type and the plurality of data values for the second vehicle data type, based on the relational pattern between the plurality of data values for the first vehicle data type and the plurality of data values for the second vehicle data type, determining a value regarding the vehicle, and controlling operation of a component of the vehicle based on the determined value.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a schematic diagram of a vehicle having a controller configured to determine the mass of the vehicle, according to an exemplary embodiment.

FIG. 2 is a schematic diagram of the controller of the vehicle of FIG. 1, according to an exemplary embodiment.

FIG. 3A is a flow diagram of vehicle operation data used to determine the mass of the vehicle, according to an exemplary embodiment.

FIG. 3B is a flow diagram of a classification process used to determine the mass of the vehicle, according to an exemplary embodiment.

FIG. 4 is a flow diagram of a method of determining the mass of a vehicle, according to an exemplary embodiment.

FIG. 5 is a graph showing a pattern of vehicle operating parameters used to determine the mass of the vehicle, according to a first exemplary embodiment.

FIG. 6 is another graph showing a pattern of vehicle operating parameters used to determine the mass of the vehicle, according to a second exemplary embodiment.

### DETAILED DESCRIPTION

Following below are more detailed descriptions of various concepts related to, and implementations of, systems and methods for determining the mass of a vehicle based on a correlated pattern between one or more vehicle parameters. More specifically, systems and methods for determining the mass of a vehicle in real time or nearly real time during vehicle operation are described herein. The mass determination system and method described herein allows for accurate vehicle mass estimation, which may then be broadcasted to vehicle managers, remote operators (e.g., fleet managers), original equipment manufacturers, etc. for vehicle monitoring and control. Further, the mass determination system and method described herein may allow the mass of the vehicle to be estimated without requiring the use of mass-specific sensors (e.g., load sensors etc.) thus reducing the cost and complexity of the systems needed to determine the mass of the vehicle. The omission of using load information from a load sensor may reduce vehicle costs, reduce malfunction and/or tampering opportunities, and improve uptime of accurate vehicle mass calculations due to not relying on sensor(s) that could malfunction. In other embodiments, a different sensor or multiple sensors may also be omitted to determine a vehicle mass. While the term “mass” is used throughout herein, it should be understood that other similar terms may also be used herein interchangeably, such as weight.

The various concepts introduced above and discussed in greater detail below may be implemented in any number of ways, as the concepts described are not limited to any particular manner of implementation. Examples of specific implementations and applications are provided primarily for illustrative purposes.

Referring to the Figures generally, various embodiments disclosed herein relate to systems and methods for determining and estimating a mass of a system, such as a vehicle, without or substantially without the use of sensors that detect the pay load on the vehicle. Typically, the mass of a vehicle is estimated using various sensors on the vehicle by deriving the force and acceleration of the vehicle and then estimating the mass of the vehicle based on Newton's second law (i.e., force=mass×acceleration). However, accuracy of this typical method of determining the mass of the vehicle is dependent on an accuracy of an acceleration value, which is a noisy signal that in turn leads to errors in the vehicle mass estimation. As described herein, various vehicle parameters (e.g., vehicle speed, engine speed, engine power, engine revolutions-per-minute, etc.) may be grouped together, patterns correlated, and a mass of the vehicle determined in real-time or near real-time based on the recognized and determined patterns. In this way, using the noisy acceleration signal to determine the mass of the vehicle is not necessary, which leads to a relatively more accurate vehicle mass estimation compared to traditional processes. Specifically, the system and methods described herein determine the mass of the vehicle by receiving vehicle operating data including one or more vehicle parameters, filtering and selecting the vehicle operating data, and then evaluating the vehicle operating data using machine learning to recognize one or more patterns between the vehicle operating parameters to determine an estimated mass of the vehicle based on the recognized patterns. After determining or estimating the mass of the vehicle, a controller of the vehicle may control various systems, such as a fueling system to control a fuel injection amount that is correlated to a load and mass of the vehicle, a hydraulic system to provide the required power, etc. These and other features and benefits are described more fully herein below.

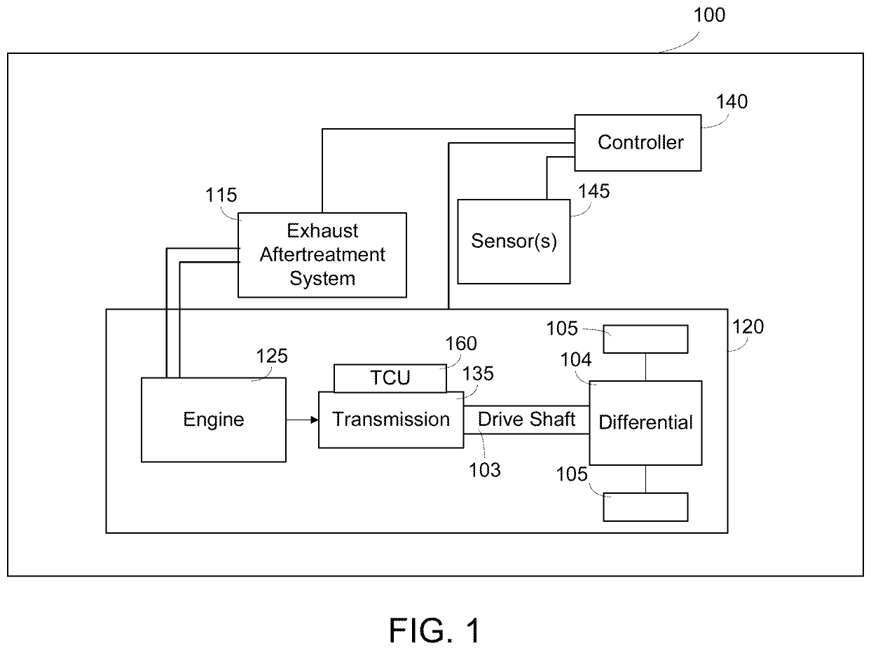

Referring now to FIG. 1, a vehicle 100 is shown, according to an example embodiment. The vehicle 100 may be configured as an on-road or an off-road vehicle (e.g., front end loaders, bulldozers, dump trucks, etc.) including, but not limited to, line-haul trucks, mid-range trucks (e.g., pick-up truck), cars (e.g., sedans), and any other type of vehicle.

The vehicle 100 may be structured as an internal combustion engine driven vehicle (e.g., gasoline, diesel, natural gas or another type of fuel that is combusted and used to power the vehicle), an at least partially hybrid vehicle (e.g., parallel or series hybrid vehicle that includes one or more electric motors and one or more internal combustion engines), a full electric vehicle (e.g., no internal combustion engine), a fuel cell or another alternative energy-driven vehicle, and so on. In the example shown, the vehicle 100 is driven, at least partly, by an internal combustion engine.

The vehicle 100 is shown to include a powertrain system 120 having an internal combustion engine 125. The powertrain system 120 facilitates power transfer from the engine 125 to power and/or propel the vehicle 100. In some embodiments as indicated above, the powertrain system 120 may be an electric/hybrid powertrain. The powertrain system 120 includes an engine 125 operably coupled to a transmission 135 that is operatively coupled to a drive shaft 103, which is operatively coupled to a differential 104, where the differential 104 transfers power output from the engine 125 to the final drive, which is shown as wheels 105, but may be tracks or other final drives in other embodiments.

If the powertrain system 120 is an electric/hybrid powertrain, it may include one or more electric machines such as a motor and/or motor generator. The electric machine may include a torque assist feature, a regenerative braking energy capture ability, a power generation ability, and any other feature of motor generators used in hybrid vehicles. The electric machine may include a power conditioning device such as an inverter and a motor controller.

As a brief overview, the engine 125 receives a chemical energy input (e.g., a fuel such as gasoline or diesel) and combusts the fuel to generate mechanical energy, in the form of a rotating crankshaft. As a result of the power output from the engine 125, the transmission 135 may manipulate the speed of the rotating input shaft (e.g., the crankshaft) to effect a desired drive shaft 103 speed. The rotating drive shaft 103 is received by a differential 104, which provides the rotation energy of the drive shaft 103 to the final drive 105. The final drive 105 then propels or moves the vehicle 100.

The engine 125 may be structured as any internal combustion engine (e.g., compression-ignition or spark-ignition), such that it can be powered by any fuel type (e.g., diesel, ethanol, gasoline, etc.). In the example shown, the engine 125 is structured as a compression-ignition engine that combusts diesel fuel. The transmission 135 may be structured as any type of transmission, such as a manual transmission, an automatic-manual transmission, an automatic transmission (e.g., a dual-clutch transmission, semi-automatic, and other types of automatic transmission), etc. In the example shown, the transmission 135 comprises a plurality of gears or settings and is an automatic transmission, such that shifting may be controlled automatically and without user input by an electronic control unit (e.g., the controller 140 and/or another ECU). Via the plurality of settings or gears, the transmission can affect different output speeds based on the engine speed. The final drive 105 may be structured in any configuration dependent on the application (e.g., the final drive 105 is structured as wheels in an automotive application like as shown with the vehicle 100). Further, the drive shaft 103 may be structured as a one-piece, two-piece, and a slip-in-tube driveshaft based on the application.

The transmission 135 may be operably coupled to a transmission control unit (TCU) 160. The TCU 160 may be communicably coupled to the controller 140 and may receive vehicle information, commands, instructions, etc. from the controller 140. The TCU 160 may be configured to monitor the status of the transmission 135 (e.g., monitor transmission settings) and change the transmission settings (e.g., shift gears) based on information regarding the vehicle 100. The TCU 160 may comprise one or more processing circuits having one or more memory devices coupled to one or more processors. The TCU 160 may at least partly control operation of the transmission 135 including, but not limited to, shifting the transmission from one gear or setting to another gear or setting. The TCU 160 may communicate information regarding the transmission to the controller 140. In some embodiments, the controller 140 may control, at least partly, the transmission 135 in lieu of the TCU 160. In this instance, the TCU 160 may be included with the controller 140.

As also shown, the vehicle 100 includes an exhaust aftertreatment system 115 coupled to and particularly, in fluid communication with, the engine 125. The exhaust aftertreatment system 115 receives exhaust gas from the combustion process in the engine 125 and reduces the emissions from the engine 125 to less environmentally harmful emissions (e.g., reduce the NOx amount, reduce the emitted particulate matter amount, etc.). The exhaust aftertreatment system 115 may include one or more of various components used to reduce engine exhaust emissions, such as a selective catalytic reduction catalyst, a diesel oxidation catalyst, a diesel particulate filter, a diesel exhaust fluid doser coupled to a supply of diesel exhaust fluid, a plurality of sensors for monitoring the exhaust aftertreatment system 115 (e.g., a NOx sensor, CO sensor, particulate matter sensors, a greenhouse gas sensor, exhaust gas flow and pressure sensors, ammonia sensors, etc.), a three-way catalyst, an exhaust aftertreatment system heater, etc. It should be understood that other embodiments may exclude an exhaust aftertreatment system and/or include different, less than, and/or additional components than that listed above. Further, the spatial arrangement of the components/systems of the exhaust aftertreatment are highly configurable. All such variations are intended to fall within the spirit and scope of the present disclosure.

The vehicle 100 also includes one or more sensor(s) 145 which may be configured to provide information about the vehicle 100 to the controller 140. In some embodiments, the one or more sensors 145 may include a vehicle velocity sensor which is configured to measure or otherwise acquire information indicative of the velocity or speed of the vehicle 100 and send this information to the controller 140. Other sensors 145 may also be included in the vehicle including, but not limited to, temperature sensors (e.g., acquire temperature information regarding operation of the engine and/or another component of the vehicle), cameras (e.g., a back-up camera, front camera, etc.), pressure sensors (e.g., exhaust manifold pressure sensor, etc.), oxygen sensors, power source rotational speed sensor, motive power sensor, and so on. In some embodiments, the sensors may include a clutch sensor which is configured to determine when the clutch is actuated. In some embodiments, the sensors may include a brake sensor which is configured to determine when the brake is actuated (e.g., depressed, at least partly, etc.). For example, the brake sensor may be a Hall Effect sensor or other suitable sensor. The controller 140 may determine the beginning and end of a sample period, as will be explained in more detail below, based on the actuation of the brake and/or clutch as determined by brake sensor and/or the clutch sensor.

The sensors 145 may be real or virtual (i.e., a non-physical sensor that is structured as program logic in the controller 140 that makes various estimations or determinations). For example, an engine speed sensor may be a real or virtual sensor arranged to measure or otherwise acquire data, values, or information indicative of a speed of the engine 125 (typically expressed in revolutions-per-minute). The sensor is coupled to the engine (when structured as a real sensor), and is structured to send a signal to the controller 140 indicative of the speed of the engine 125. When structured as a virtual sensor, at least one input may be used by the controller 140 in an algorithm, model, lookup table, etc. to determine or estimate a parameter of the engine (e.g., engine power output, etc.). Any of the sensors 145 described herein may be real or virtual.

The controller 140 is coupled to the powertrain 120, the exhaust aftertreatment system 115, and the one or more sensors 145. The controller 140 may be structured to control, at least partly, the operation of the vehicle 100. Communication between and among the components may be via any number of wired or wireless connections as described herein with respect to the communications interface 240. Because the controller 140 is communicably coupled to the systems and components in the vehicle 100 of FIG. 1, the controller 140 is structured to receive data (e.g., instructions, commands, signals, values, etc.) from one or more of the components of the vehicle 100 shown in FIG. 1. This may generally be referred to as internal vehicle information (e.g., data, values, etc.). The internal vehicle information represents determined, acquired, predicted, estimated, and/or gathered data regarding one or more components in vehicle 100.

The controller 140 may be configured to determine the mass of the vehicle 100 based on determined predefined correlated patterns of one or more vehicle parameters (e.g., vehicle speed and vehicle power, engine power and fueling, etc.) of the vehicle 100. More specifically, the controller 140 is configured to receive vehicle operating data from the one or more sensors 145 (alternatively, from a remote source such as from a remote computing system via a network). The controller 140 may then be configured to filter the vehicle operating data and determine one or more vehicle parameters based on the filtered vehicle operating data. The controller 140 may then be configured to evaluate the vehicle parameters using a machine learning model to recognize patterns between/among two or more of the vehicle parameters and determine the mass of the vehicle based on the determined and/or recognized patterns.

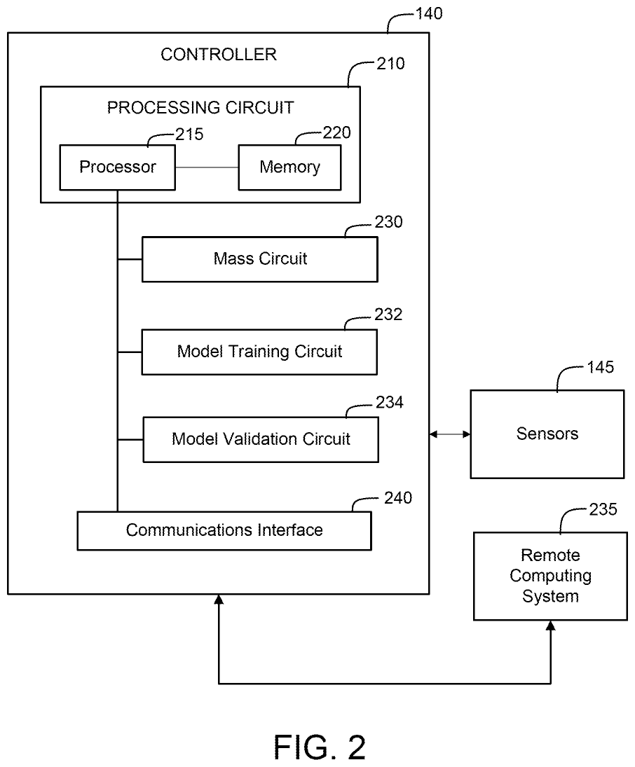

As the components of FIG. 1 are shown to be embodied in a vehicle, the controller 140 may be structured as one or more electronic control units (ECUs). The controller 140 may be separate from or included with at least one of the transmission control unit 160, an exhaust aftertreatment control unit, a powertrain control module, an engine control module, etc. In one embodiment, the depicted components of the controller 140 are combined into a single unit. In another embodiment, one or more of the components of the controller 140 (or other controllers not depicted, such as an aftertreatment system controller, etc.) may be geographically dispersed throughout the vehicle (e.g., in separate locations of the vehicle). When there are multiple controllers or components, a datalink (e.g., a J1939 communication network) or CAN bus may connect the multiple controllers to provide shared information. The datalink (or other communication structures) allows the controller 140 to recognize faults, failures, and other information from each of the connected controllers or components. The function and structure of the controller 140 is described in greater detail in FIG. 2.

Referring now to FIG. 2, a schematic diagram of the controller 140 of the vehicle 100 of FIG. 1 coupled to the one or more sensors 145 is shown, according to an example embodiment. In some embodiments, the controller 140 controls the operation of various vehicle components (e.g., the engine 125, the transmission 135, and/or the TCU 160).

As shown in FIG. 2, the controller 140 includes a processing circuit 210 having at least one processor 215 coupled to at least one memory or memory device 220. The controller 140 also includes a mass circuit 230, a model training circuit 232, a model validation circuit 234, and a communications interface 240. The controller 140 is structured or configured to determine the mass of the vehicle 100.

In one configuration, the mass circuit 230, the model training circuit 232, and the model validation circuit 234 may be embodied as instructions that are executable by a processor, such as processor 215 and stored by at least one memory device. As described herein and amongst other uses, the instructions facilitate performance of certain operations to enable reception and transmission of data. For example, the instructions may enable providing an instruction (e.g., command, etc.) to, e.g., acquire data. In this regard, the instructions may be embodied as programmable logic that defines the frequency of acquisition of the data (or, transmission of the data). The instructions may be stored in computer readable media, and be embodied as code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the mass circuit 230, the model training circuit 232, and the model validation circuit 234 may be embodied as one or more hardware units, such as electronic control units. In turn, the mass circuit 230, the model training circuit 232, and the model validation circuit 234 may be may be embodied as one or more circuitry components including, but not limited to, processing circuitry, network interfaces, peripheral devices, input devices, output devices, sensors, etc. In some embodiments, the mass circuit 230, the model training circuit 232, and the model validation circuit 234 may be may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the mass circuit 230, the model training circuit 232, and the model validation circuit 234 may be a may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The mass circuit 230, the model training circuit 232, and the model validation circuit 234 may be may also include programmable hardware devices such as field programmable gate arrays, programmable array logic, programmable logic devices or the like. The mass circuit 230, the model training circuit 232, and the model validation circuit 234 may be may include one or more memory devices for storing instructions that executable by the processor(s) of the mass circuit 230, the model training circuit 232, and the model validation circuit 234 may be. The one or more memory devices and processor(s) may have the same or similar definition as provided below with respect to the memory device 220 and processor 215. In some hardware unit configurations, components of the mass circuit 230, the model training circuit 232, and the model validation circuit 234 may be may be geographically dispersed throughout separate locations in the vehicle. Alternatively and as shown, the mass circuit 230, the model training circuit 232, and the model validation circuit 234 may be may be embodied in or within a single unit/housing, which is shown as the controller 140.

In the example shown, the controller 140 includes the processing circuit 210 having the processor 215 and the memory device 220. The processing circuit 210 may be structured or configured to execute or implement the instructions, commands, and/or control processes described herein with respect to the mass circuit 230, the model training circuit 232, and the model validation circuit 234 may be. The depicted configuration represents the mass circuit 230, the model training circuit 232, and the model validation circuit 234 as instructions stored in non-transitory machine or computer-readable media. However, as mentioned above, this illustration is not meant to be limiting as the present disclosure contemplates other embodiments the mass circuit 230, the model training circuit 232, and the model validation circuit 234 may be is configured as a hardware unit. All such combinations and variations are intended to fall within the scope of the present disclosure.

The processor 215 may be one or more of a single-or multi-chip processor, a digital signal processor (DSP), an application specific integrated circuit (ASIC), a field programmable gate array (FPGA), a programmable logic device, discrete gate or transistor logic, discrete hardware components, another type of suitable processor, or any combination thereof designed to perform at least some of the functions described herein. In this way, the processor 215 may be a microprocessor, a state machine, or other suitable processor. The processor 215 also may be implemented as a combination of computing devices, such as a combination of a DSP and a microprocessor, a plurality of microprocessors, one or more microprocessors in conjunction with a DSP core, or any other such configuration. Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 220 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 220 may be communicably coupled to the processor 215 to provide computer code or instructions to the processor 215 for executing at least some of the processes described herein. Moreover, the memory device 220 may be or include tangible, non-transient volatile memory or non-volatile memory storing instructions that are executable by the processor to perform various operations. Accordingly, the memory device 220 may include database components, object code components, script components, or any other type of information structure for supporting the various activities and information structures described herein.

The mass circuit 230 is structured to receive raw vehicle operating data for the vehicle 100 (e.g., from the sensors 145, etc.). The received vehicle operating data may be filtered to generate filtered vehicle operating data which may be used to determine the mass of the vehicle. The filtered vehicle operating data may include, but are not limited to, a vehicle speed, a vehicle power (which may be represented by an engine torque and speed), an engine speed, a motive power source rotational speed, a net brake torque, a fueling value, a motor speed, a motor current and/or a motor voltage, a service brake value which may be indicative of a status of the service brake (e.g., operational, faulty based on a presence of a fault code regarding the service brake, etc.), a clutch value, a gear value, and/or a road grade value (which may either be sensed or estimated). The received vehicle operating data may be derived from information received from one or more sensors 145 (e.g., engine speed sensor, torque sensor, etc.) and/or other sources (e.g., a remote computing system that provides an altitude of the vehicle). The mass circuit 230 stores one or more equations, tables, and/or algorithms regarding relational patterns regarding the one or more vehicle parameters. As described herein, the mass circuit 230 may be configured or structured to determine the mass of the vehicle based on the relational patterns between the one or more vehicle parameters.

In some embodiments, the mass circuit 230 may be configured filter the raw vehicle operation data before using the vehicle operation data to determine the mass of the vehicle. For example, the mass circuit 230 may apply an averaging filter (e.g., moving average filter, Gaussian filter, median filter, etc.). As another example, the mass circuit 230 may apply a windowing filter (e.g., a low pass filter, FIR filter, Hanning filter, Blackman-Harris filter, Kaiser-Bessel filter, etc.).

In some embodiments, the mass circuit 230 includes one or more machine learning models which are configured to receive and ingest the filtered vehicle operating data, determine relational patterns between the filtered vehicle operating data, and then determine the mass of the vehicle based on the patterns recognized, identified, or otherwise determined.

The model training circuit 232 is structured to train one or more machine learning models using the using the filtered vehicle operating data (e.g., a vehicle speed, a vehicle power, an engine speed, a motive power source rotational speed, a net brake torque, etc.) as determined by the mass circuit 230. The machine learning model(s) can include a random forest model, a statistical learning model, a neural network, regression model, and/or a machine learning model of another type. In some embodiments, the machine learning model(s) may also include one or more lookup tables or graphs which may be used to support the inferences and estimations made by the machine learning models. Training a machine learning model includes the model training circuit 232 selecting initial coefficients or parameters of the model. The model training circuit 232 can select an architecture or configuration of the model and assign initial values for the parameters of the model to be estimated. The model training circuit 232 can apply the values of the filtered vehicle operating data as input to the machine learning model, and compare the outputs of the machine learning models to the labels associated with the parameter values of the selected parameters. In some embodiments, the model training circuit 232 can train one or more random forest models (or random decision forests), e.g., with distinct architectures and/or different discrete classes. Training multiple machine learning models provides a plurality of trained models to choose from, e.g., at the validation stage by the model validation circuit 234. In some embodiments, the model training circuit 232 can train one or more neural networks with multiple hidden layers being used.

In some implementations, the model training circuit(s) 232 can train multiple machine learning models, e.g., either of the same type or of different types, for vehicle mass determination. For instance, the model training circuit(s) 232 can train multiple random forest models (or random decision forests) with distinct architectures, such as various differing number of nodes/classifications, using the parameter values of the selected subset of parameters. Training multiple machine learning models provides a plurality of trained models to choose from at a validation stage.

The model validation circuit(s) 234 is structured to validate the trained machine learning model(s) provided by the model training circuit(s) 232, using a validation or test data. The validation or test data includes vehicle operating data determined by the mass circuit 230. In some embodiments, the model validation circuit 234 may designate a portion of the “training data” used by the model training circuit 232 as validation data for testing the performance of the models created by the model training circuit 232. The validation data may be associated with known values which correspond to a known mass so that a user can evaluate the accuracy of the model. The validation or testing process provides an assessment of how reliable the trained machine leaning model is in determining the mass of the vehicle based on an input data set different of the training data set. In some implementations, the model validation circuit 234 can validate or test each of a plurality of trained machine learning models, and select, determine, or otherwise identify the best performing model for deployment to estimate the moving mass of the vehicle. The best performing model may be defined as the machine learning model which most accurately able to estimate the mass of the vehicle using the filtered vehicle operating data as an input.

The communications interface 240 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and out-of-vehicle communications (e.g., with a remote server). For example and regarding out-of-vehicle/system communications, the communications interface 240 may include an Ethernet card and port for sending and receiving data via an Ethernet-based communications network and/or a Wi-Fi transceiver for communicating via a wireless communications network. The communications interface 240 may be structured to communicate via local area networks or wide area networks (e.g., the Internet) and may use a variety of communications protocols (e.g., IP, LON, Bluetooth, ZigBee, radio, cellular, near field communication, etc.). In some embodiments, out-of-vehicle communications may be provided via a telematics unit such that the communications interface may be incapable of out-of-vehicle communications.

The communications interface 240 may facilitate communication between and among the controller 140 and one or more components of the vehicle 100 (e.g., the engine 125, the transmission 135, the TCU 160, the exhaust aftertreatment system 115, the sensors 145 etc.). Communication between and among the controller 140 and the components of the vehicle 100 may be via any number of wired or wireless connections (e.g., any standard under IEEE). For example, a wired connection may include a serial cable, a fiber optic cable, a CAT5 cable, or any other form of wired connection. In comparison, a wireless connection may include the Internet, Wi-Fi, cellular, Bluetooth, ZigBee, radio, etc. In one embodiment, a controller area network (CAN) bus provides the exchange of signals, information, and/or data. The CAN bus can include any number of wired and wireless connections that provide the exchange of signals, information, and/or data. The CAN bus may include a local area network (LAN), or a wide area network (WAN), or the connection may be made to an external computer (for example, through the Internet using an Internet Service Provider).

In some embodiments, the controller 140 is coupled to a remote computing system 235 (e.g., a server or cloud-based computing system) whereby one or more of the processes discussed herein is accomplished in one or more processors of the remote computing system 235. The remote computing system 235 may be associated with, managed by, owned by, and/or otherwise controlled by a vehicle manufacturer, a vehicle system or component manufacturer (e.g., an OEM), a fleet manager for multiple vehicles, an agency (e.g., a government agency for tracking emissions and fleet operations, etc.), and/or another entity. The remote computing system 235 may include one or more processing circuits having one or more processors coupled to one or more memory devices, one or more communications interfaces for communicating with one or more vehicles and other computing systems, and other suitable hardware and program logic. The remote computing system 235 may be configured as a backend server system, a cloud computing system, and/or other suitable computing system. The remote computing system 235 may be configured or structured to perform various operations.

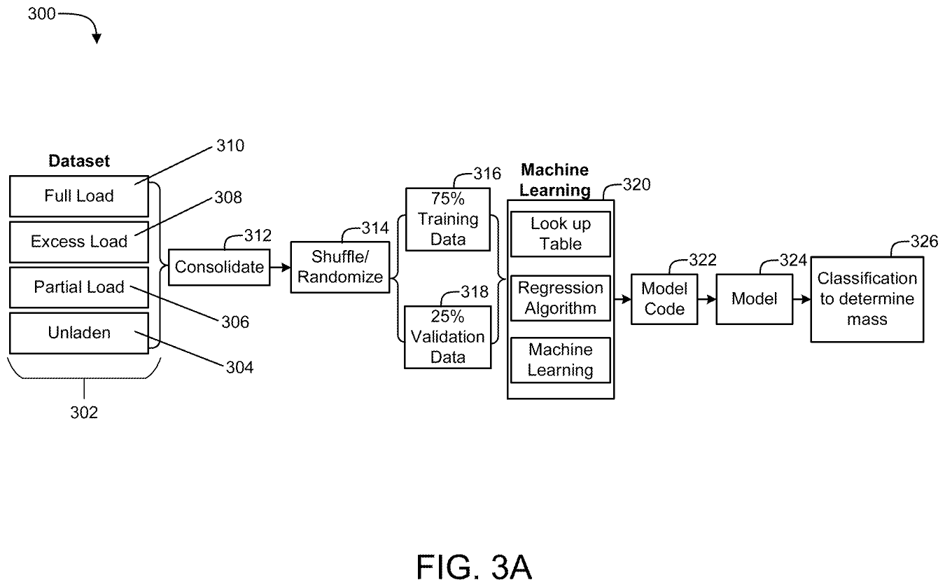

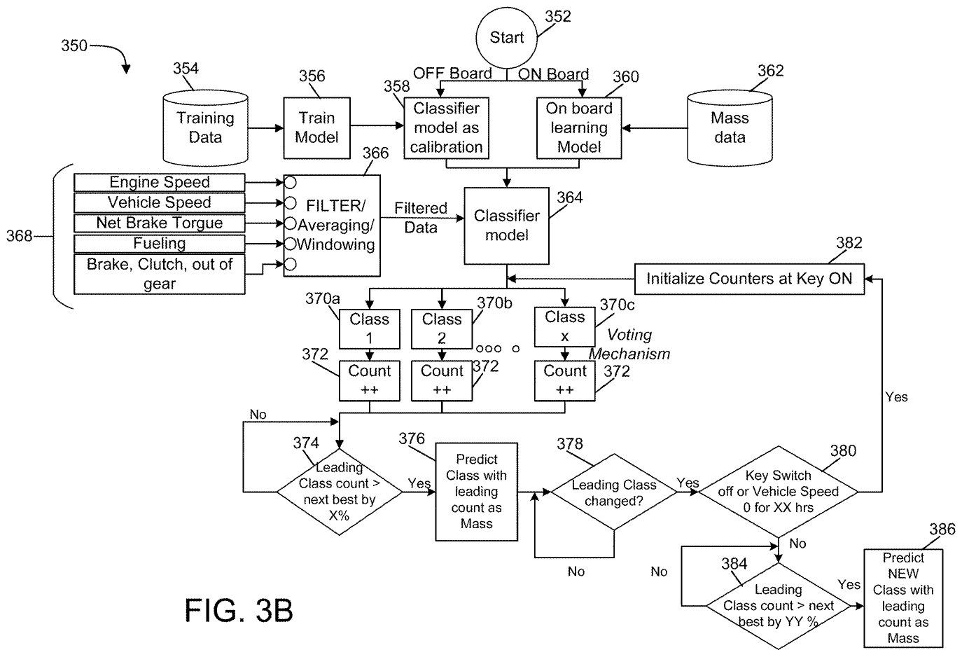

Referring now to FIG. 3A, a flow diagram of a method 300 for processing data which may be used to determine the mass of the vehicle is shown, according to an example embodiment. In some embodiments, the method 300 may be performed by the controller 140. In some embodiments, the method 300 may be performed by the remote computing system 235 either in combination with the controller 140 or independent of controller 140. The method 300 starts at 302 with a vehicle operation data set being received by the controller 140. For example, the controller 140 may receive vehicle operation data from the sensors 145. The vehicle operation data forms the vehicle operation data set. In some embodiments, the vehicle operation data set may be divided into one or more subgroups by the controller 140. The data subgroups may include vehicle operation data that was collected under different operating conditions. In one embodiment, the data subgroups are based on a constant or relatively constant (e.g., within a predefined value or amount of) vehicle speed. In some embodiments, the data subgroups are based on a different determining factor. As a specific example, data subgroup 304 may include vehicle operation data which was collected when the vehicle was not carrying a load (e.g., “unladen”) at a first set of constant or relatively constant vehicle speeds. As another example, data subgroup 306 may include vehicle operation data which was collected when the vehicle was carrying a partial load (e.g., “partial load”) at a second set of constant or relatively constant vehicle speeds. As another example, data subgroup 308 may include vehicle operation data which was collected when the vehicle was carrying a load over a certain threshold (e.g., “excess load”) at a third set of constant or relatively constant vehicle speeds. As a final example, data subgroup 310 may include vehicle operation data that was collected when the vehicle was carrying a full load (e.g., “full load”) at a fourth set of constant or relatively constant vehicle speeds. In some embodiments, the sets of vehicle speeds are the same. In other embodiments, at least one set of vehicle speeds is different from at least one other set of vehicle speed. In yet another embodiment, the vehicle speed is one only vehicle speed range and not a set of various speed ranges.

The controller 140 may divide the data into the data subgroups 304, 306, 308, and 310 based on the vehicle information received from the sensors 145 and/or the remote computing system 235. For example, the controller 140 may receive vehicle information for a plurality of vehicles (e.g., trucks) that was collected on through the remote computing system 235. This vehicle information may include a timestamp for when the data was collected, an identifier associated with the vehicle, and a status of the vehicle (e.g., the value of load carried by vehicle throughout operation that may indicate whether the vehicle is fully loaded, partially loaded, or unladen). In other embodiments, the controller may classify the vehicle data into these categories based on the vehicle data itself. For example and for given type of vehicle, the controller 140 may compare the determined mass of the vehicle (as described herein) to subsequently classify that data into the pertinent categories. Based on this information, the controller 140 can divide the vehicle operation information received from the plurality of vehicles into the subgroups outlined above by comparing the received information to known values which indicate the sub-group.

At data subgroups 304, 306, 308, and 310 may be consolidated into a single and comprehensive data set at 312 by the controller 140. The vehicle operation data may be shuffled and/or randomized by the controller 140 to ensure or attempt to ensure that no bias or patterns exists within the vehicle operation data set before the vehicle operation data is split to create a training data set at 316 and a validation data set at 318. In some embodiments, the controller 140 may designate that a first portion of the vehicle operation data set may be utilized to train the machine learning models as described above with respect to model training circuit 232. Further, the controller 140 may designate that a second portion of the vehicle operation data set may be utilized to validate or test the machine learning models as described above with respect to model validation circuit 234. In the exemplary embodiment shown in FIG. 3, the first portion is a majority of the data (e.g., greater than 50%, such as greater than 75%) of the vehicle operation data set while the second portion is a remainder of the data (e.g., 25% when the first portion is 75%) of the vehicle operation data set. However, this embodiment is only meant to be exemplary and the first and second portions may be different percentages than what is explicitly contemplated herein.

The controller 140 uses the vehicle operation data is to generate and test machine learning models at 320. The machine learning model(s) created at 320 may include but is not limited to a random forest model, a statistical learning model, a neural network, regression model, and/or a machine learning model of another type. In some embodiments, machine learning model may be implemented using with a model code at 322. The model code created at 322 may be a computer programming structured to implement the machine learning models to create the model at 324. The model code may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.). The machine learning models may be used to determine the mass of the vehicle at 326 during operation of the vehicle. Specifically, the controller 140 may continue to receive “live” vehicle operation data as the vehicle is in operation, evaluate the live vehicle operation using machine learning model (e.g., a classifier model) generated and trained in method 300, and determine the moving or live mass of the vehicle based on the evaluation. “Live vehicle operation data” refers to vehicle operation data that is collected and evaluated in real time while the vehicle is running or moving. A moving mass of the vehicle refers to an estimated mass of the vehicle determined while the vehicle is operation or running. The process for evaluating the live vehicle operation data and determining the mass of the vehicle is explained in more detail below with respect to FIG. 3B.

Referring now to FIG. 3B, a flow diagram of a method 350 for evaluating live vehicle operation data using machine learning to determine a moving mass of the vehicle is shown, according to an example embodiment. In some embodiments, the method 350 may be performed by the controller 140. In some embodiments, the method 350 may be performed by the remote computing system 235 either in combination with the controller 140 or independent of controller 140.

The method 350 begins at 352 by the controller 140 determining whether the process is being run on-board a vehicle or off-board a vehicle. In the off-board process, the learning (e.g., training and validation) of the machine learning model for estimating the mass takes place entirely offline using legacy data, simulations, lab testing, etc. The machine learning model, which is created offline and parameters cannot be changed, may then be used to estimate the mass of the vehicle. In contrast, in the on-board process, learning of the machine learning model can take place online or at least partially online. This allows the user to have an option to input real time or substantially real time data for the vehicle (e.g., the tonnage the vehicle is carrying, etc.). For example, a truck scale may be used to determine the weight of the truck, and this information (minus the weight of the truck) is provided to the controller either automatically (e.g., a wireless connection with the scale) or manually (e.g., via an operator via an I/O device coupled to the controller). The real time data can then be used to update the machine learning model. The on-board process allows the vehicle mass estimation model to adapt to the specific vehicle. If the method 350 is being run off-board the vehicle, then the method 350 is training the model to be used as a calibration for the on-board machine learning model. Specifically, training data 254 may be used to train the machine learning model at process 356 using similar techniques as described herein. The machine learning model trained at 356 may be used to calibrate the on-board machine learning model 360 to create the classifier model 364. In some embodiments, the on-board learning model may be generated based on mass data 362 using similar techniques as described. The mass data 362 may refer to the real time data (e.g., the tonnage the vehicle is carrying) which may be used to update the on board learning model.

The classifier model 364 is type of machine learning model which predicts the class or category of data received by the model. For example, the classifier model may include multiple different classes and may sort the data received into the multiple classes. In the particular application described herein, the classifier model 364 may be configured to receive vehicle operation data and sort the vehicle operation data into different mass classes. For example, the mass of vehicle may fall into one of four or five categories. For example, the first class may range from a first weight range (e.g., 20-24 tons, etc.), the second class may range from a second weight range (e.g., 25-30 tons, etc.), the third class may range from a third weight range (e.g., 31-36 tons, etc.), the fourth class may range from a fourth weight range (e.g., 37-40 tons, etc.), and the fifth class may range from a fifth weight range (e.g., 41-46 tons, etc.). The classifier may be configured to receive vehicle operation data 368, evaluate the vehicle operation data using machine learning, and classify the vehicle to a certain class as having a certain mass based on the vehicle operation data. In some embodiments, the classifier model may be a decision tree model, a Naive Bayes model, a k-nearest neighbors model, a support vector machines model, or an artificial neural network model, a random forest model, or a logistic regression model. In some embodiments, the classifier may be a combination of the aforementioned machine learning models.

In some embodiments, the controller 140 may filter the vehicle operation data 368 before the vehicle operation data is evaluated by the classifier model 364. For example, the controller 140 may apply an averaging filter (e.g., moving average filter, Gaussian filter, median filter, etc.). As another example, the mass circuit 230 may apply a windowing filter (e.g., a low pass filter, FIR filter, Hanning filter, Blackman-Harris filter, Kaiser-Bessel filter, etc.). Once the vehicle operation data 368 is filtered, the filtered data may then be evaluated by the classifier model 364. The classifier model determines the mass of the vehicle by determining a correct class for the vehicle based on multiple data values determined from the vehicle operation data. For example for a first data value or data point, the classifier model 364 may place the vehicle in a first class 370 and increase the count of the data values which indicate the vehicle is in the first mass class at 372a. Then for a second data value or data point, the classifier model may also place the vehicle in the first class 370 and increase the count of the data which indicate the vehicle is in the first mass class at 372a. Then for a third value or data point, the classifier model 364 may place the vehicle in a second class 370b and increase the count of the data values which indicate that the vehicle is in the second class at 372b. At this point, since the majority of the data values indicated that the vehicle is in the first class, the classifier model may determine that the mass of the vehicle is within the first class.

The classifier model 364 may be configured to evaluate multiple data values from the filtered vehicle operation data 368. For example, the classifier model 364 may evaluate multiple data points associated with an engine speed, a vehicle speed, a net brake torque, fueling, a brake, clutch, or gear position, and/or a road grade value either sensed or estimated. Based on these data values, the classifier may assign the vehicle to a certain weight class. For example, the classifier model may receive a plurality of engine speed values and a plurality vehicle speed values for a vehicle operating at a certain time where the first engine speed value is correlated to the first vehicle speed value, the second engine speed value is correlated to the second vehicle speed value, and so forth. Based on the relationship between the first engine speed value and the first vehicle speed value, the classifier model may classify the mass of the vehicle as being in the first class. The classifier model 364 may classify the mass of the vehicle as being in any of the classes 370a-370b based on the relationship between the related engine speed values and vehicle speed values. Whenever the classifier model classifies mass of the vehicle as being in a particular class or category, the count of the amount of times the vehicle has been assigned to that class increases. For example, if the relationship between the engine speed and vehicle speed for 14 out of the 20 data values leads to the mass of the vehicle being assigned to the first class 370a, the count 372a for the first class will be 7. In this example, the relationship of the remaining data values (e.g., 6) may have caused the classifier model to assign the mass of the vehicle to the second class 370b leading to the count of the second class being 3.

The process then proceeds to 374 where the controller 140 determines which class has a leading count and if the difference between the counts for the different class is above a certain margin. If the count of the class with the most assignments is larger than the next highest count by a certain predefined margin, then the process proceeds to 376 where the controller 140 determines that the mass of the vehicle is in the class with the highest count. If the count of the class with the most assignments is not larger than the next highest count by a certain margin, then the process returns to 374 and the classifier model 364 continues to receive data and classify the mass of the vehicle until the condition at 374 is true. After the mass of the vehicle has been estimated at 376, the controller 140 continues to monitor the classifications made by the classifier model 364 to determine whether the class with the highest count has changed at 378. If the leading class has changed, the controller 140 determines whether a vehicle off event has occurred at 380. In some embodiments, the controller 140 may determine that a vehicle off event has occurred if the key switch is in an off position or if the speed of the vehicle has been zero for a predetermined amount of time. If the vehicle is experiencing an off event at 378, then the counts 327a-372c for the classes 370a-370b are erased and the method reverts back to the classifier model 364 classifying the data values when the key moves to an on position at 382. If the vehicle is not experiencing an off event, then the controller 140 determines whether the new leading count of the class with the most assignments is larger than the next highest count by a certain margin at 384. If the new leading count is higher the next highest count by a certain predefined margin, then the process proceeds to 386 where the controller 140 determines that new mass of the vehicle is in the new class with the highest count. If the count of the class with the most assignments is not larger than the next highest count by a certain margin, then the process stays at 384 and the classifier model 364 continues to receive data and classify the mass of the vehicle until the condition at 384 is true.

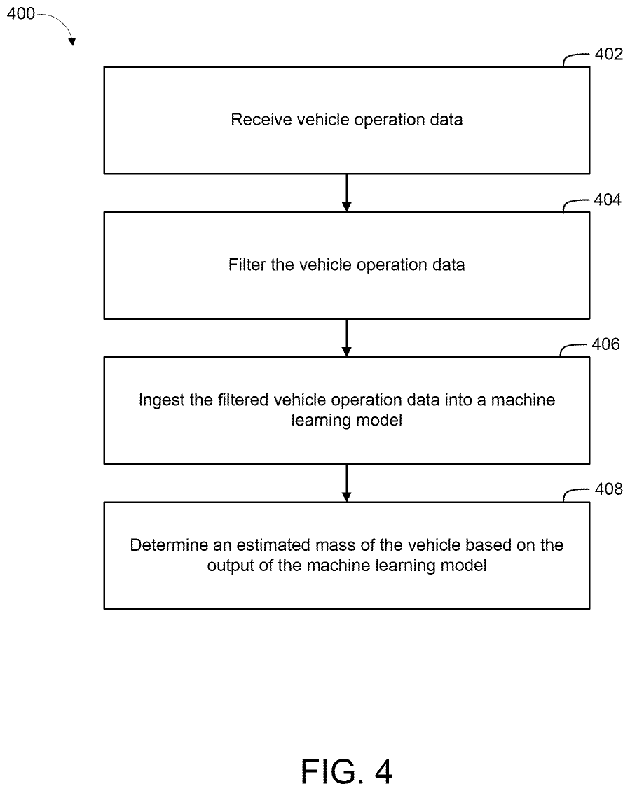

Referring now to FIG. 4, a method 400 for calculating, estimating, and/or otherwise determining the mass of the vehicle is shown, according to an exemplary embodiment. In some embodiments, the method 400 is generally configured to determine the mass of the vehicle by receiving vehicle operating data, filtering the vehicle operating data, and then evaluating the filtered vehicle operating data using machine learning to recognize one or more relational patterns between the vehicle operating parameters and determining the mass of the vehicle based on the recognized relational patterns. In some embodiments, the method 400 may be performed by the controller 140. In some other embodiments, one or more processes may be performed by the remote computing system 235 in combination with the controller 140.

The method 400 begins at process 402 with the controller 140 receiving the vehicle operation data. The vehicle operation data may include sensor information about the movement of the vehicle and the fuel use for the vehicle. For example, at process 402, the controller may receive vehicle operation data from an engine speed sensor, a torque sensor, and/or fuel sensor. The received vehicle operating data may be utilized to determine the moving mass of the vehicle.

At process 404, the controller 140 may be configured to filter the vehicle operation data received at process 402. Specifically, the controller 140 may be configured to filter the vehicle operation data before using the vehicle operation data to determine the mass of the vehicle. For example, the controller 140 may filter the vehicle operation data by applying an averaging filter (e.g., moving average filter, Gaussian filter, median filter, etc.). As another example, the controller 140 may filter the vehicle operation data by applying a windowing filter (e.g., a low pass filter, FIR filter, Hanning filter, Blackman-Harris filter, Kaiser-Bessel filter, etc.).

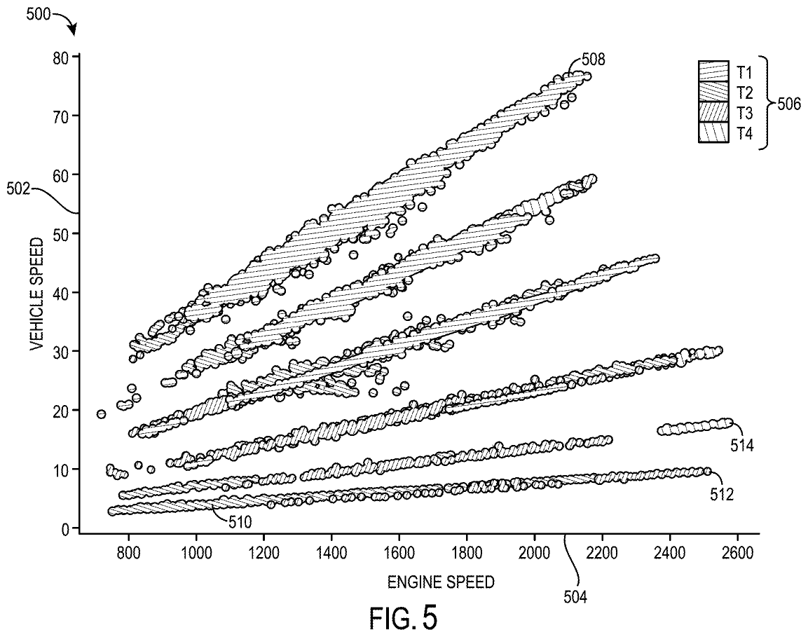

At process 406, the controller 140 is configured to ingest the filtered vehicle operation data into a machine learning model. The machine learning model may be configured to analyze the ingested filtered vehicle operation data to recognize one or more patterns within the data. Specifically, the filtered vehicle operation data may include, but is not limited, a vehicle speed, a vehicle power (which may be represented by an engine torque and speed), an engine speed, a motive power source rotational speed, a net brake torque, a fueling value, a motor speed, a motor current and/or motor voltage, a service brake value, a clutch value, a gear value, and/or a road grade value either sensed or estimated. The machine learning models may be configured to receive the filtered vehicle operation data and use machine learning techniques to recognize one or more patterns within the filtered vehicle operation data. For example, the machine learning model may be configured to recognize a correlated pattern between the engine speed and vehicle speed. Specifically, referring now to FIG. 5, a graph 500 showing values which may be used by the machine learning model to recognize multiple relational patterns between the engine speed and the vehicle speed is shown, according to an exemplary embodiment. The graph 500 includes a y-axis 502 which plots the multiple data values for vehicle speed on the graph 500. The graph 500 also includes an x-axis 504 which plots multiple data values for the engine speed on graph 500. As can be seen, the vehicle operation data form relational patterns (e.g., patterns 508, 510, 512, and 514) can be categorized into mass categories 506. Specifically, the mass categories 506 may include a first mass category T1, a second mass category T2, a third mass category T3, and a fourth mass category T4. Data values for the vehicle speed which have a certain relationship with the data values for the engine speed may be used to determine that a vehicle which exhibits such a relationship between the data values for the two types of vehicle operating data as having a certain mass. For example, if the data values for a first vehicle data type (e.g., vehicle speed) have the same relationship to a second vehicle data type (e.g., engine speed) as pattern 508, the controller 140 may estimate the mass of the vehicle as being in the first mass category T1. A machine learning model, can be trained to recognize such patterns between vehicle data types and their corresponding determined mass estimates. Based on the patterns 508, 510, 512, and 514, the machine learning model can compare any future vehicle operation data received to the patterns used to create (e.g., train and validate) the machine learning model to determine the mass of the vehicle.

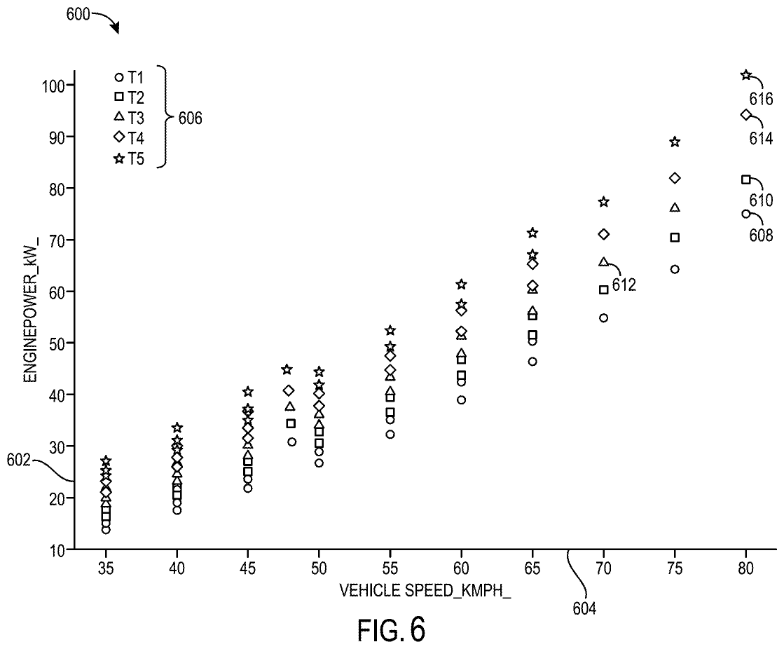

Further, referring now to FIG. 6, another graph 600 showing values which may be used by the machine learning model to recognize multiple relational patterns between vehicle operation data types is shown, according to an exemplary embodiment. However, the vehicle operation data used in graph 600 may vary from those used in graph 500. Specifically, the vehicle operation data used in graph 600 includes an engine power and a vehicle speed. The graph 600 includes a y-axis 602 which plots multiple data values for the engine power on the graph 600. The graph 600 also includes an x-axis 604 which plots multiple data values for the vehicle speed on graph 600. As can be seen, the vehicle operation data form relational patterns (e.g., patterns 608, 610, 612, 614, and 616) that can be categorized into mass categories 606. Specifically, the mass categories 606 may include a first mass category T1, a second mass category T2, a third mass category T3, a fourth mass category T4, and a fifth mass category T5. Data values for the vehicle speed which have a certain relationship with the data values for the engine speed may be used to determine that a vehicle which exhibits such a relationship between the data values for the two vehicle operation data types as having a certain mass. For example, if the data values for a first vehicle operation data type (e.g., engine power) have the same relationship to a second vehicle operation data type (e.g., vehicle speed) as pattern 608, the controller 140 may estimate the mass of the vehicle as being in the first mass category T1. A machine learning model, can be trained to recognize such patterns between vehicle operation data types to determine a mass estimate for the vehicle. Based on the relational patterns 608, 610, 612, 614, and 616, the machine learning model can compare any future vehicle operation data types received to the patterns used to create (e.g., train and validate) the machine learning model to determine the mass of the vehicle. Though graphs 500 and 600 only display the use of the vehicle speed, the engine speed, and/or the engine power, this example is not meant to limiting. Relational patterns can be determined between any of the vehicle operation data types described herein (e.g., a vehicle speed, a vehicle power (which may be represented by an engine torque and speed), an engine speed, a motive power source rotational speed, a net brake torque, a fueling value, a motor speed, a motor current and/or motor voltage, a service brake value, a clutch value, a gear value, and/or a road grade value either sensed or estimated).

The controller 140 may then be able to determine the mass of the vehicle based on the mass category determined by the vehicle. In some embodiments, the machine learning model may be at least one of, but is not limited, to a random forest model, a statistical learning model, a neural network, regression model, and/or a machine learning model of another type. In some embodiments, the machine learning model may be implemented using a computer program using one or more programing languages.

Based on the correlated patterns recognized by the machine learning model, the controller 140 may be configured to determine a weight class of the vehicle based on the output of the machine learning model. Specifically, as described above, the machine learning models may be configured to compare current or predicted vehicle operating data to the patterns demonstrated in graphs 500 and 600 and categorize the vehicles into a mass category. Based on the mass category, the controller 140 can determine the mass of the vehicle. For example, the first mass category may be associated with 22 tons. Therefore, if a vehicle is categorized into the first mass category, then the controller will determine a mass of 22 tons.

In some embodiments, the controller 140 may control one or more components of the vehicle based on the estimated mass of the vehicle as determined by the controller. For example, the controller 140 may use the estimated mass when making gear shift decisions in a transmission in order to attempt to achieve one or more objective, such as to attempt to improve fuel economy. As another example, the controller 140 may broadcast the estimated mass of the vehicle to the remote computing system 235. The remote computing system 235 may use the estimated mass of the vehicle to monitor a fleet of vehicles, determine vehicle usage patterns, and/or determine service intervals for one or more vehicles in the fleet. The remote computing may also use the estimated mass of the vehicle to command drafting arrangements for the vehicle relative to other vehicles in the fleet to improve fuel economy and accomplish fleet operational objectives. As another example, the controller 140 may control the torque of the engine 125 based on the estimated mass of the vehicle to improve fuel economy. As another example, the controller 140 may control the vehicle to limit the maximum acceleration based on the estimated mass of the vehicle to improve fuel economy. As another example, the estimated mass may be used by the controller 140 with a cruise control operating mode and/or with assisted braking. Based on the estimated mass of the vehicle, the controller 140 can estimate the acceleration the vehicle may require to maintain a speed for cruise control (cruise control operating mode) and a brake force that would be or likely required for stopping the vehicle using assisted braking.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It should be understood that the controller 140 may include any number of circuits for completing the functions described herein. Additional circuits with additional functionality may also be included. Further, the controller 140 may further control other activity beyond the scope of the present disclosure.

As mentioned above and in one configuration, the “circuits” may be implemented in machine-readable medium storing instructions for execution by various types of processors, such as the processor 215 of FIG. 2. Executable code may, for instance, comprise one or more physical or logical blocks of computer instructions, which may, for instance, be organized as an object, procedure, or function. Nevertheless, the executables need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices.

While the term “processor” is briefly defined above, the term “processor” and “processing circuit” are meant to be broadly interpreted. In this regard and as mentioned above, the “processor” may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising computer or machine-readable media for carrying or having computer or machine-executable instructions or data structures stored thereon. Such machine-readable media can be any available media that can be accessed by a computer. The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device. Machine-executable instructions include, for example, instructions and data which cause a computer or processing machine to perform a certain function or group of functions.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present disclosure may be written in any combination of one or more other programming languages, including an object oriented programming language such as Java, Smalltalk, C++ or the like and conventional procedural programming languages, such as the “C” programming language or similar programming languages. The computer readable program code may execute entirely on the user's computer, partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods may be accomplished with standard programming techniques with rule-based logic and other logic to accomplish the various connection steps, processing steps, comparison steps, and decision steps.

It is important to note that the construction and arrangement of the apparatus and system as shown in the various exemplary embodiments is illustrative only. Additionally, any element disclosed in one embodiment may be incorporated or utilized with any other embodiment disclosed herein.

What is claimed is:

1. A method, comprising:
receiving vehicle operating data;
filtering the vehicle operating data;
determining a plurality of data values for a first vehicle data type and a plurality of data values for a second vehicle data type based on the filtered vehicle operating data;
determining, by a machine learning model, a relational pattern between the plurality of data values for the first vehicle data type and the plurality of data values for the second vehicle data type;
based on the relational pattern between the plurality of data values for the first vehicle data type and the plurality of data values for the second vehicle data type, determining a value regarding the vehicle; and
controlling operation of a component of the vehicle based on the determined value.

2. The method of claim 1, wherein the determined value is an estimated mass of the vehicle.

3. The method of claim 1, wherein the first vehicle data type and the second vehicle data type are at least one of a vehicle speed, a vehicle power, an engine speed, a motive power source rotational speed, a net brake torque, a fueling value, a motor speed, a motor current, a motor voltage, a service brake value, a clutch value, or a gear value.

4. The method of claim 3, wherein the first vehicle data type is different from the second vehicle data type.

5. The method of claim 1, wherein the filtering the vehicle operating data comprises applying at least one of an averaging filter or a windowing filter.

6. The method of claim 1, wherein controlling the operation of the component includes controlling a transmission or a power output from a power source of the vehicle.

7. The method of claim 1, wherein the machine learning model includes at least one of a random forest model, a statistical learning model, a neural network, or a regression model.

8. The method of claim 1, wherein the method further comprises:
training the machine learning model using vehicle operating data values; and
validating the trained machine learning model to identify a best machine learning model to deploy.

9. The method of claim 1, wherein the method further comprises:
receiving a real-time update regarding a tonnage of load carried by the vehicle; and
updating the machine learning model based on the real time update.

10. A system for determining a value regarding a vehicle that is used to control the vehicle, the system comprising:
one or more processors; and
at least one memory coupled to the one or more processors, the at least one memory storing executable instructions, which when executed by the one or more processors, cause the one or more processors to:
receive vehicle operating data;
filter the vehicle operating data;
determine a plurality of data values for a first vehicle data type and a plurality of data values for a second vehicle data type based on the filtered vehicle operating data;
determine, by a machine learning model, a relational pattern between the plurality of data values for the first vehicle data type and the plurality of data values for the second vehicle data type;
based on the relational pattern between the plurality of data values for the first vehicle data type and the plurality of data values for the second vehicle data type, determine a value regarding the vehicle; and
control operation of a component of the vehicle based on the determined value.

11. The system of claim 10, wherein the determined value is an estimated mass of the vehicle.

12. The system of claim 10, wherein the first vehicle data type and the second vehicle data type are at least one of a vehicle speed, a vehicle power, an engine speed, a motive power source rotational speed, a net brake torque, a fueling value, a motor speed, a motor current, a motor voltage, a service brake value, a clutch value, or a gear value.

13. The system of claim 12, wherein the first vehicle data type is different from the second vehicle data type.

14. The system of claim 10, wherein the instructions, when executed by the one or more processors, further cause the one or more processors to:
train the machine learning model using a first portion of the vehicle operating data; and
validate the trained machine learning model using a separate second portion of the vehicle operating data, wherein the first portion is larger amount of the vehicle operating data than the second portion.

15. The system of claim 10, wherein controlling the operation of the component includes controlling the transmission or a power output from a power source of the vehicle.

16. The system of claim 10, wherein the machine learning model includes at least one of a random forest model, a statistical learning model, a neural network, or a regression model.

17. A non-transitory computer readable medium storing instructions therein that, when executed by one or more processors, cause the one or more processors to perform operations comprising:
receiving vehicle operating data;
filtering the vehicle operating data;
determining a plurality of data values for a first vehicle data type and a plurality of data values for a second vehicle data type based on the filtered vehicle operating data;
determining, by a machine learning model, a relational pattern between the plurality of data values for the first vehicle data type and the plurality of data values for the second vehicle data type;
based on the relational pattern between the plurality of data values for the first vehicle data type and the plurality of data values for the second vehicle data type, determining a value regarding the vehicle; and
controlling operation of a component of the vehicle based on the determined value.

18. The non-transitory computer readable medium of claim 17, wherein the determined value is an estimated mass of the vehicle.

19. The non-transitory computer readable medium of claim 17, wherein the vehicle operating data is divided into a plurality of data subgroups, wherein the plurality of data subgroups includes full load data, excess load data, partial load data, and no load data.

20. The non-transitory computer readable medium of claim 17, wherein the filtering the vehicle operating data comprises applying at least one of an averaging filter or a windowing filter.
